(19) United States
(12) Patent Application Publication
(10) Pub. No.: US 2001/0034605 A1
(43) Pub. Date: Oct. 25, 2001

(54) Three-tiered portal

(76) Inventor: Roger P. Hoffman, Green Bay, WI (US)

Correspondence Address: Philip M. Weiss, Weiss & Weiss, 500 Old Country Road, Suite 305, Garden City, NY, 11530, US

(21) Appl. No.: 09/765,763

(22) Filed: Jan. 19, 2001

Related U.S. Application Data
(60) Provisional application No. 60/177,266, filed on Jan. 21, 2000.

(51) Int. Cl. G06F 17/60

(52) U.S. Cl. 705/1

(57) ABSTRACT

The present invention relates to an integrated portal system comprising industry related portals.

### FIELD OF THE INVENTION

The present invention relates to an integrated portal system comprising industry related portals.

### BACKGROUND OF THE INVENTION

Most of the Portals which people use today are broadly structured portals. If one wanted to search for “ties”, one would get thousands of hits between industries depending on how this term is defined in that industry. There are also portals on the Internet today which relate to a single industry, such as paper, steel or chemicals. There is no system today which allows a user to create a portal which includes all the industries relating to the user's industry. If a businessman in the paper industry logs onto a paper cite on the Internet and wishes to purchase chemicals, they must then log onto a separate cite for chemicals. Further in order to view news, or other information relating to their company a user must view several cites before gaining the information required.

There are several cites which give a user access to several industries, but each industry is a separate domain with its own search engine and its own news.

Most businesses today have Internet services provided to all of their employees. Employees abuse their use of the Internet to look up items that are not related to their employment, because employees have no restrictions on what they can view on the Internet. There is no system which allows an employee to enter a portal on the Internet which assists a user with the functions of their job. There is no system which in a timely and cost effective manner provides a user of the Internet a way to assist the user with their job.

### SUMMARY OF THE INVENTION

The present invention provides a three-tier portal system wherein the system contains a MacroPortal, MiniPortal and MicroPortal. The system allows a business to limit what features each employee will be allowed with their Internet rights.

The present invention will facilitate transactions between companies without necessitating a wholesale change in current business practices. This is possible using a three-tiered portal system. Users are able to experience a global portal which will integrate all vertical market (“Mini”) portals. For each vertical market portal there exist several Micro-Portals that enable the present invention to capture the transactional nuances of specific niches within industries. This enables the content and transactions to be tailored at a much more intuitive level than that provided by a single vertical market portal.

It is an object of the present invention to provide an integrated portal system comprising; an industry related portal, and a second portal of a different industry. The system of the present invention integrates the portals so that a user can view information relating to both portals in a single system. This allows a user to create a virtual community. The present invention allows a user to review all the necessary information, news and events within a single system. It is an object of the present invention to provide a system wherein said user can perform transactions in said single system. It is an object of the present invention for each of said portals to contain a mini portal and a micro portal. It is an object of the present invention for the system to have a search engine, which can search a single portal having micro and mini portals or to search between portals. It is an object of the present invention to provide a system for providing transaction tracking information. It is an object of the present invention to provide product specification charts. It is an object of the present invention to provide online communication between individuals within an industry related portal and a second portal.

It is an object of the present invention to provide a method for creating an integrated portal system comprising; entering job characteristics of a user. Based on the job characteristics, the system creates an integrated portal system.

It is an object of the present invention to provide an industrial database comprising; a search engine, product or service specifications and independent product reports; and a system for answering questions from a user. It is an object of the present invention to provide a list of vendors and vendor product information. It is an object of the present invention for the vendor product information to be updated automatically from a vendor's website. It is an object of the present invention to provide a characteristic template. It is an object of the present invention to provide a usage template. It is an object of the present invention to provide a price analysis mechanism.

It is an object of the present invention for a user to enter characteristics of their job and for the system of the present invention to provide the appropriate integrated portal. It is an object of the present invention to allow a user to customize an integrated portal.

It is an object of the present invention to provide a search engine, which allows a restricted search within a specific industry or within related industries. The present invention provides a vertical market portal.

It is an object of the present invention to provide a system for handling transactions, content and branding.

It is an object of the present invention to provide a content management system that distills relevant information from micro and mini portals to higher levels based on the needs of the broader audience. As information distills upward it is made less technical and condensed to allow the less deeply more broadly knowledgeable individual to capture the message.

### BRIEF DESCRIPTION OF THE DRAWINGS

FIG. 1 shows an example of a three-tier portal.

### DETAILED DESCRIPTION OF THE INVENTION

In a preferred embodiment, a my page service provides a user a customizable homepage accessing and displaying information from all available Portal services. Upon logging in, the user has the option of going to a homepage which contains the information the user specifically requested to be available and customized. For example, users' may request that their homepages display all relevant industry news, the commodity prices of certain commodities, weather conditions in a certain region, etc.

Users are able to customize their pages at anytime. My Page serves as the users jumping off point for surfing the site.

In a preferred embodiment, a user's corporate My Pages contains certain standard items including:

Transaction tracking information—Including Request for Quotation Processing (for buyers)

Product Specification Charts

Request for Quotation shopping cart

Specific vendor supplied news—news and information supplied directly from vendors

Request for Quotation Inbox

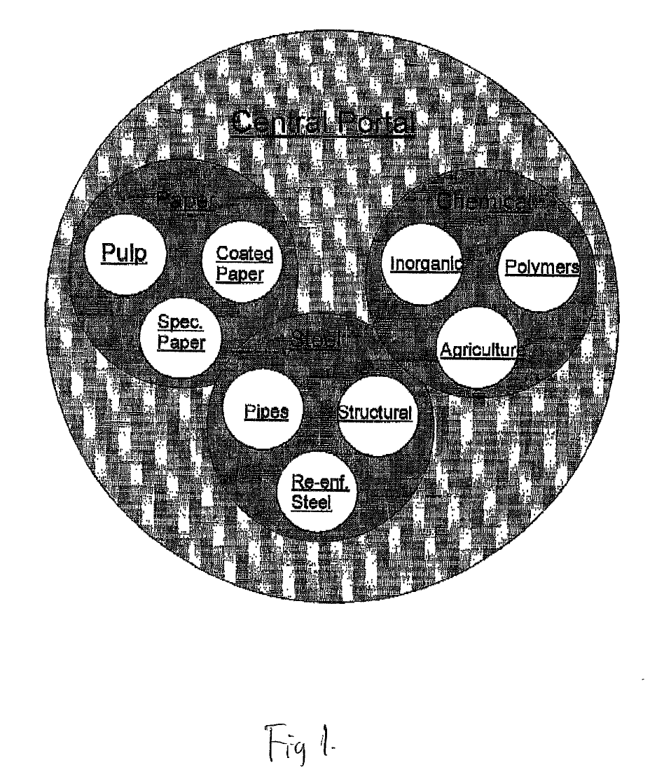

FIG. 1 illustrates an example of a Three-Tiered Portal System. Within the central portal or MacroPortal of FIG. 1 are three MiniPortals; paper, steel and chemical. Since the paper business is related to the steel and chemical business these MiniPortals are related portals so that one could search the paper MiniPortal or search portals related to the paper MiniPortal , the steel and chemical MiniPortals. Within the paper MiniPortals are MicroPortals, for example, relating to pulp, coated paper, and specialty paper. Within the steel MiniPortals are MicroPortals, for example, relating to pipes, structural and reinforced steel. Within the chemical MiniPortals are MicroPortals relating to inorganic, polymers and agricultural chemicals. In a preferred embodiment, the system of the present invention can integrate miniportals of different industries.

For example, with a company such as a major paper company, the top people in the company require knowledge of a broad variety of topics not just within the paper industry, but in related industries. The present invention provides this person with a MacroPortal to the paper industry and related industries in which the person can conduct business and use a search engine within this portal. A lower level person in the company may not require knowledge of similar industries, but may require knowledge of a variety of paper industry products. This person would have access to the MiniPortal of paper in which to conduct business and use a search engine within this portal. A further person in this company who specifically deals with coated paper would only have access to the MicroPortal of coated paper section. This person may not require access to the other areas in the paper industry and therefore would have limited access to coated paper as far as the search engine and other features described in the present invention.

The database of the present invention allows a search of a term within a specific industry and related industries, a specific industry only, or within a part of a specific industry. If one wanted to search for the term “tensile strength”, one could look in the MacroPortal to search within a number of related portals, search within the MiniPortal of paper or search within the MicroPortal of coated paper.

In a preferred embodiment product and service specifications are provided. Information is provided relating to manufacturing specifications, standards and testing methods. In addition, suppliers provide information relating to their products. In a preferred embodiment information includes:

Product specifications—Seller supplied product specifications

Product characteristics—Seller supplied product characteristics

Product suggestions—Industry expert and seller supplied product suggestions

Independent product reports—Access to independent product testing information

For example, if a user is in the paper MiniPortal, in the specialty paper MicroPortal, certain specialty papers require specific twisting characteristics to be used for wrapping taffy candies. However, users may be unsure or mistaken as to which pulp possesses the required twisting characteristics. In a preferred embodiment specific types of products are listed and the user is given the opportunity to answer questions regarding the particular uses for which they require the paper. Based on their responses, paper selections are suggested to them. The paper selection grid enables users to easily and officially identify and select, for instance, the specialty paper with the most appropriate twisting characteristics for wrapping taffy candies or the highest moisture resistance.

The web sites for each distinct industry niche are separately branded however, all product information is stored in the same database. Each different distinct industry niche has its own separate MicroPortal.

In a preferred embodiment the present invention to provides a content management system that distills relevant information from micro and mini portals to higher levels based on the needs of the broader audience. As information distills upward it is made less technical and condensed to allow the less deeply more broadly knowledgeable individual to capture the message.

As an example in an electrical power MicroPortal that dealt with the availability of power in California would have detailed information available in the MicroPortal but would have been more broadly described to clearly forecast the impending crisis presently in California in the MiniPortal.

In a preferred embodiment, all vendors are stored in the database. Vendors provide their products to buyers who request quotations on the products sold by the vendors. In a preferred embodiment, each vendor is able to update information on their products and services on the web site and each vendor has its own section which enables them to update their product offerings. In a preferred embodiment, the present invention has a spreadsheet, template in which vendors can update the database. In another embodiment the present invention dials into the vendors computer systems and regularly retrieves files which define the products to be offered.

In a preferred embodiment, products are searchable via several methods. It is important to know that products may have hundreds of characteristics attached to them. In a preferred embodiment users are allowed to search among all available characteristics. Users can create their own template which define what characteristics are important to them. In a preferred embodiment each characteristic is also hyperlinkable to a glossary and other pertinent industry information.

In a further embodiment the user is able to select products by usage. The database stores the characteristics that are important by usage. For example, if the paper that will be manufactured from the pulp is to be used as a candy wrapper, the characteristics that are associated with twisted qualities are highlighted on a saved characteristic template.

In a further embodiment users may select products directly from particular vendors. In a further embodiment a user may select from a characteristic template. In a preferred embodiment, these templates could be viewed as product grids which would have columns that define the product name and all other characteristics that are available on the template. Users are able to customize the grid to include the characteristics that they are interested in. Once customized, the grids can be saved for future viewing at a later date.

In a further embodiment, a user can search via an AD-HOC query. Users are able to query the characteristics database in order to ask random questions such as: “show me all pulp with a tear factor greater than ninety and brightness less than eight-five which have been manufactured at 500 CSF”.

In a further embodiment the system provides a response analysis for ranking participating vendors. This service details how long it ordinarily takes for buyers to receive responses to submitted quotes from specific vendors. Actual statistics on responses to request for quotations (RFQ'S) are accumulated and available to users. Examples of tracking statistics include RFQ turn around time and average delivery time.

In a preferred embodiment the present system allows users to enter RFQ'S for specific products and services. Users are able to solicit request for quotation from specific companies as well as from all possible suppliers or vendors. The quotation may be provided to the user instantly on the web site, or by e-mail to the user at a later time.

In a preferred embodiment, an RFQ is saved to the RFQ database and the proper vendors are notified that a new RFQ has been submitted. Vendors can go in and respond to the request. As new responses arrive at the RFQ database the buyer is notified of it and may go in and check the details. Users may choose to send multiple RFQ'S simultaneously. Before an RFQ can be sent to suppliers, buyers are required to fill out an RFQ form. This form includes important information from the buyer's perspective, such as acceptable pricing and delivery time. Once an RFQ is sent, the supplier receives an email announcing that they have received an RFQ.

There are a number of ways that a supplier may choose to process an RFQ to produce a quotation:

1. Automatically e-mail the RFQ to other internal sources.

2. Print the RFQ form locally.

3. Have the RFQ converted to an EDI transmission and sent to their internal quoting software.

4. Send directly to their database, however, this would require customization.

5. Save to differing file format such as Excel, Word, etc.

In a preferred embodiment the present invention provides pricing analysis on products to the users. Pricing analysis includes: average prices, price fluctuations, and expected price changes over defined time blocks plus standard pricing analysis methods.

The present invention provides users with the ability to conduct all of their business to business transactions online. Applications include:

Identify optimal supplier based upon product performance criteria, available capacity, logistics costs, and pricing;

Enable customers to directly schedule orders and receive notification of shipment from the optimal supplier;

Electronically automate order-related correspondence including invoices, shipping manifests, and payments;

Allow suppliers to track customers' inventories in real-time and manage inventories at optimal levels;

Enable logistics companies to bid on shipments by having the visibility of a larger market;

Permit customers to select their preferred supplier.

Users have the ability to:

Identify potential sellers and buyers;

Conduct research on potential buyers and sellers;

Request quotations;

Accept offers;

Arrange and complete financing;

Inquire about and secure transportation;

Track delivery.

In a further embodiment the present invention provides users the ability to track products while they are being manufactured. Efficiency is increased because authorized users have the ability to access and modify supply process information from any location with Internet access. The service also serves as an indicator when an order is in the supply process. In a preferred embodiment users are provided with tracking numbers. Tracking numbers allow users to identify and contact the source of the quotation and to access available information on the supplier or vendor who returned the quotation.

In a further embodiment the present invention provides inventory tracking. Users are able to track the exact location of the products that have been shipped or ordered. This information is updated throughout the shipment cycle period.

In a further embodiment the present invention provides a logistics RFQ. Suppliers first submit a logistics service request. Service providers then bid on the shipment and notification is sent to suppliers to go in and select the best bid. Transaction parties can track shipment with the aid of a geographical interface.

In a further embodiment the system provides an inventory control function. Here, buyers can enter their product requisition list and vendors can enter their inventory schedules. When a match occurs the system will electronically notify both parties and wait for their approvals to complete and settle their transactions.

In a further embodiment the present invention provides specific industry news to the user. To those users who are logged into the paper MiniPortal , relevant industry information is available, such as, news on forest fires, floods, labor issues, military conflicts and proposed government regulations. More specific industry news will be provided in a MicroPortal.

In a further embodiment the present invention provides industry specific statistics. The following are some examples of statistical information which could be provided to a user in the paper MiniPortal:

Sales of pulp;

Sales of paper;

Sales of raw materials;

Linerboard production versus last year's and last month's production;

Linerboard average inventory total; weeks of supply and changes from previous level;

Pricing major paper grades;

Spot inventory levels.

Raw industry statistics are stored in a centralized database. This database is periodically updated and will track changes over time. Users are able to create customized graphs based on the statistics found within the database. Many of the statistics tracked has a forecasting component which will be stored in the database also.

In a further embodiment the present invention provides commodity prices of raw materials and other commodities pertinent to the specific MiniPortal . Regular updates are made to all commodity quotas.

In a further embodiment the present invention provides an online market place for mergers and acquisitions. Information pertaining to companies that wish to be acquired is available to potential purchasers. Additionally, the present invention exhibits public information concerning pending and recently completed mergers and acquisitions within the particular industry. A current list and information regarding pending SEC filings for mergers and acquisitions is also be compiled and maintained.

In a further embodiment, the present system allows users to arrange and facilitate financing for purchases, mergers, acquisitions and other services. Users will be able to receive the credit reports from rating bureau's such as Dun & Bradstreet. This enables users to instantly determine the ability of potential purchasers to pay.

In a further embodiment the present invention enables online communication between individuals within a specific industry. The present invention provides separate chat rooms for members of each individual niche within an industry. Furthermore, users within an industry can be broken down geographically as well. In a preferred embodiment community services include:

User Profiles—Users have the option of completing a user profile detailing their contact information.

Instant Messaging—Users have the capability to instant message each other.

Forums—Forums allow users to post questions and receive answers.

Chat Rooms—Multiple parties will have the ability to accomplish real time chatting.

These communication services are an integral part of the site because they enable individuals to network with their existing business partners and aid them in identifying potential new partners.

In a further embodiment the present invention provides the user with personal and group calendars. The service enables individuals and companies to document and keep abreast of:

Daily Meetings—Individual and group meetings;

Appointments—Individual and group appointments;

Internal Corporate Events—Internal Company events such as Christmas parties, company conferences, and company softball games;

Other Scheduled Events—Industry conferences and trade shows.

Personal and group calendars promote workplace efficiency by allowing all authorized individuals within an organization to access the information from remote locations via the Internet. Users are able to see the calendars of several individuals simultaneously rather than having to look at them one at a time.

A user may define a particular calendar event as “public”, “semi-private”, or “private” (default). No one will be able to view a private event except the user. Only individuals specifically identified by the calendar owner will be authorized to view a semi-private event. All users will have the ability to view public events. In this way another user can create a calendar by combining several others while privacy is still maintained.

In a further embodiment the present invention provides an event calendar which details upcoming conferences, industry events, seminars, trade shows, etc. Conference information includes but is not limited to:

Names of events;

Date of events;

Locations of events;

Times of events;

Directions to event facilities;

Transportation availability and options;

Participating vendors;

Cost of event admittance;

Local hotel information;

Preliminary agendas;

Contact information including phone numbers and e-mail addresses;

Ability to register for the events online;

A further section consists of future news. This includes but it is not limited to information such as:

The date a relevant crop report is to be released by the USDA;

An upcoming Federal Reserve Meeting;

Government Monthly inflation reports.

A further section consists of Transaction Oriented Events. These events are created from user transactions. The type of events that can be traced are: expected shipments, RFQ submittal due dates, and receipt of payment.

A further embodiment provides event hosting. The present invention hosts events with full multi media content. Event sponsors are able to run video and sound clips to hundred of users. Vendors will have the capability to host virtual online trade shows. These can include closed events and press conferences. The present invention allows a user to create virtual online seminars and online speeches. The system also provides virtual online trading.

In a preferred embodiment, the present invention provides a company's profile directory. This directory will contain listings and descriptions about the company. Key information includes officers, key executives, plant locations, products and services. These facts are accompanied by brief company histories as well as links to executive profiles. Executive profiles include but are not limited to:

The companies with which the executives are employed;

Executives' educational background;

Executives' previous work experience;

Executives' contact information.

As executives move from one company to another the present invention is able to display the employment changes and will help keep people abreast of these changes in a timely and efficiently matter.

In a further embodiment the present invention provides industry specific job opportunities to individuals seeking employment within that industry. Users will have the ability to search through a job bank and send resumes electronically and confidentially to companies within the industry. Users can search by:

Job types;

Geographical locations;

Salary ranges;

Experience requirements.

Users seeking employment opportunities are able to post their resumes and peruse through classified-style employment advertisements.

In a further embodiment the present invention provides an industry specific glossary of terms. There are two aspects to the glossary:

Integrated Glossary—This glossary is integrated throughout the site and will be accessible to the user from any web page. In the integrated version, when a user clicks on a term with which they are unfamiliar, “bubble help” appears. The “bubble” definition is consistent with the portal in which the word appears.

Non-Integrated Glossary—This glossary consists of a separate service which is independently accessible and searchable.

In a further embodiment the present invention provides users the ability to conduct and participate in online business to business auctions.

In a further embodiment the present invention provides a virtual sales person that leads users through the sales process. The virtual sales person allows individuals to enter text and ask questions of a caricature icon. This will personalize the online sales experience for the user. Sales people will have the ability to upload voice templates. The sales persons caricature can speak in the sales person voice. Salespeople will be able to program their online caricature to answer certain questions concerning local weather conditions, local news, or other information that salespeople wish their customers to receive.

Salespeople can also have the ability to designate which of their customers they will deal with online.

Additionally, a virtual salesperson may be a caricature of an individual within the industry, who is recognized as an industry leader.

User's voice queries may eventually be answered through the use of voice responses or video clips.

In a further embodiment the present invention provides support for credit transactions including cross-boarder transactions and accounts receivable management. Such services include:

Incoming Electronic Funds Transfer

Assistance in receiving foreign funds sent electronically. The present invention accepts the buyer's foreign finds and disburses the sum to the seller via draft or electronic funds transfer.

Forward Contracts

With forward contracts, businesses conducting international financial transactions can protect their costs against profit erosion and unexpected budget variations resulting from currency movements.

In simple terms, a forward contract is a “buy now, pay later” arrangement. The contract allows one to lock in a rate of exchange today for currency to be purchased or sold on a future date. When an exchange rate is locked in, the U.S. dollar equivalent is protected for the duration of the contract regardless of subsequent currency fluctuations. Once the contract matures, funds may be disbursed via draft or electronic funds transfer.

Standing Orders

The Standing Order service enables the company to take advantage of favorable exchange rate when they are unable to monitor the market.

Foreign Currency Holding account

The holding account offsets incoming payments against outgoing disbursements.

Funds held in foreign currency can be used to make future payments. The result is fewer currency purchases which can reduce a company's conversion costs.

1. An integrated portal system comprising;
an industry related portal;
a second portal of a different industry;
said system integrating said portals so that a user can view information relating to both portals in a single system.

2. The system of claim 1 wherein said user can perform transactions in said single system.

3. The system of claim 1 wherein each of said portals contains a mini portal and a micro portal.

4. The system of claim 1 further comprising a search engine.

5. The system of claim 4 wherein said search engine can search within a single industry or within related industries.

6. The system of claim 1 further comprising transaction tracking information.

7. The system of claim 1 further comprising product specification charts.

8. The system of claim 2 further comprising a search engine, said engine being able to search in mini portals and micro portals.

9. The system of claim 1 further comprising;
online communication between individuals within an industry related portal and a second portals.

10. A method for creating an integrated portal system comprising;
entering job characteristics of a user;
said system creating said integrated portal system based on said job characteristics of said user.

11. An industrial database comprising;
a search engine;
said database having product or service specifications and independent product reports; and
a system for answering questions from a user.

12. The database of claim 11 further comprising;
a list of vendors and vendor product information.

13. The database of claim 12 wherein said vendor product information is updated automatically from a vendor's website.

14. The database of claim 12 wherein said database has a characteristic template.

15. The database of claim 12 wherein said database has a usage template.

16. The database of claim 12 wherein said database provides a price analysis mechanism.

17. A content management system comprising;
information stored in a MiniPortal(s);
information stored in a MicroPortal(s);
said information from said MiniPortal and said MicroPortal made less technical when it enters said MacroPortal.
